(19) United States
(12) Patent Application Publication
(10) Pub. No.: US 2015/0365251 A1
(43) Pub. Date: Dec. 17, 2015

(54) GATEWAY DEVICE AND PACKET CAPTURING METHOD

(71) Applicant: Azbil Corporation, Tokyo (JP)

(72) Inventors: Makoto KINOSHITA, Tokyo (JP); Hideki TASHIRO, Tokyo (JP)

(73) Assignee: Azbil Corporation, Tokyo (JP)

(21) Appl. No.: 14/739,501

(22) Filed: Jun. 15, 2015

(30) Foreign Application Priority Data
Jun. 16, 2014 (JP) 2014-123109

(51) Int. Cl. H04L 12/40

(52) U.S. Cl. CPC H04L 12/40

(57) ABSTRACT

A gateway device for relaying between a system bus, to which a system instrument is connected, and a field bus, to which a field instrument is connected, is used in a controlling system for controlling and monitoring facilities equipment. The gateway device includes: a packet capturing portion that captures packets that are exchanged with the field instrument over the field bus, in response to a start command from a higher-level device that is connected to the system bus; and a packet transmitting portion that transmits the captured packets, after encapsulation, to the higher-level device over the system bus.

### CROSS REFERENCE TO RELATED APPLICATION

This application claims priority under 35 U.S.C. §119 to Japanese Patent Application No. 2014-123109, filed on Jun. 16, 2014, the entire content of which being hereby incorporated herein by reference.

### FIELD OF TECHNOLOGY

The present invention relates to a controlling system technology, and, in particular, relates to a packet capturing technology for capturing packets that are exchanged with field instruments through a field bus of a controlling system.

### BACKGROUND

Typically, in controlling systems for controlling and monitoring facilities equipment such as buildings and plants, a structure is used where in two communication networks, a system bus and a field bus, are relayed through a gateway device. The system bus is a communication network for data communication between a system instrument, made from a server, or the like, and the gateway device. Moreover, the field bus is a communication network for carrying out data communication between a field instrument that collects equipment information, such as a sensor, and actuator, a valve, or the like, and the gateway device.

When, in this type of controlling system, there are problems relating to communication, such as with communication connectivity, the packets that are exchanged between the communication instruments are captured to isolate the cause of the problem, to thereby solve the problem quickly.

Although her most system buses use an Ethernet (registered trademark) for the physical layer, field buses use a variety of different protocols in the physical layer, depending on the specifications of the field instruments.

Given this, conventionally packet capturing devices having interfaces that depend on those physical layers are connected to the individual field buses, and the packets captured by the packet capturing devices are collected by a higher-level device. See, for example, Japanese Unexamined Patent Application Publication No. 2001-103090.

However, in this type of conventional technology, not only is it necessary to provide, on each individual field bus, a packet capturing device that is specialized to the physical layer of that field bus, but also necessary to be aware of the specifications of the respective packet capturing devices. Moreover, when capturing on a new field bus, sometimes it is not possible to connect a new packet capturing device without first stopping the field bus. Because of this, there has been a problem in that this increases the costs and operational overhead required in capturing packets.

The present invention is to solve such issues, and an aspect thereof is to provide a packet capturing technology able to capture packets from a field bus at a low cost with low operational overhead.

### SUMMARY

In order to achieve such an aspect, a gateway device according to the present invention, for relaying between a system bus, to which a system instrument is connected, and a field bus, to which a field instrument is connected, is used in a controlling system for controlling and monitoring facilities equipment. The gateway device includes: a packet capturing portion that captures packets that are exchanged with the field instrument over the field bus, in response to a start command from a higher-level device that is connected to the system bus; and a packet transmitting portion that transmits the captured packets, after encapsulation, to the higher-level device over the system bus.

Moreover, in another structural example of gateway device as set according to the present invention, the packet capturing portion terminates capturing after a specific amount of time has elapsed since the start command or in response to an end command from the higher-level device prior to the specific amount of time elapsing.

Moreover, in a packet capturing method according to the present invention used in a gateway device for relaying between a system bus, to which a system instrument is connected, and a field bus, to which a field instrument is connected, used in a controlling system for controlling and monitoring facilities equipment, the method includes: a packet capturing step for capturing packets that are exchanged with the field instrument over the field bus, in response to a start command from a higher-level device that is connected to the system bus; and a packet transmitting step for transmitting the captured packets, after encapsulation, to the higher-level device over the system bus.

The present invention eliminates the need to provide a dedicated packet capturing device for each individual field bus, even when there is a plurality of field buses with different specifications, and eliminates the need to stop a field bus when capturing is to be performed for a new field bus, thus making it possible to capture packets from each field bus with low cost and a low operational overhead.

### BRIEF DESCRIPTIONS OF THE DRAWINGS

FIG. 1 is a block diagram illustrating the structure of a gateway device.

FIG. 2 is an example configuration of a capsule packet.

FIG. 3 is a sequence diagram illustrating a packet capturing operation.

### DETAILED DESCRIPTION

A form for carrying out the present disclosure will be explained next in reference to the figures.

### Gateway Device

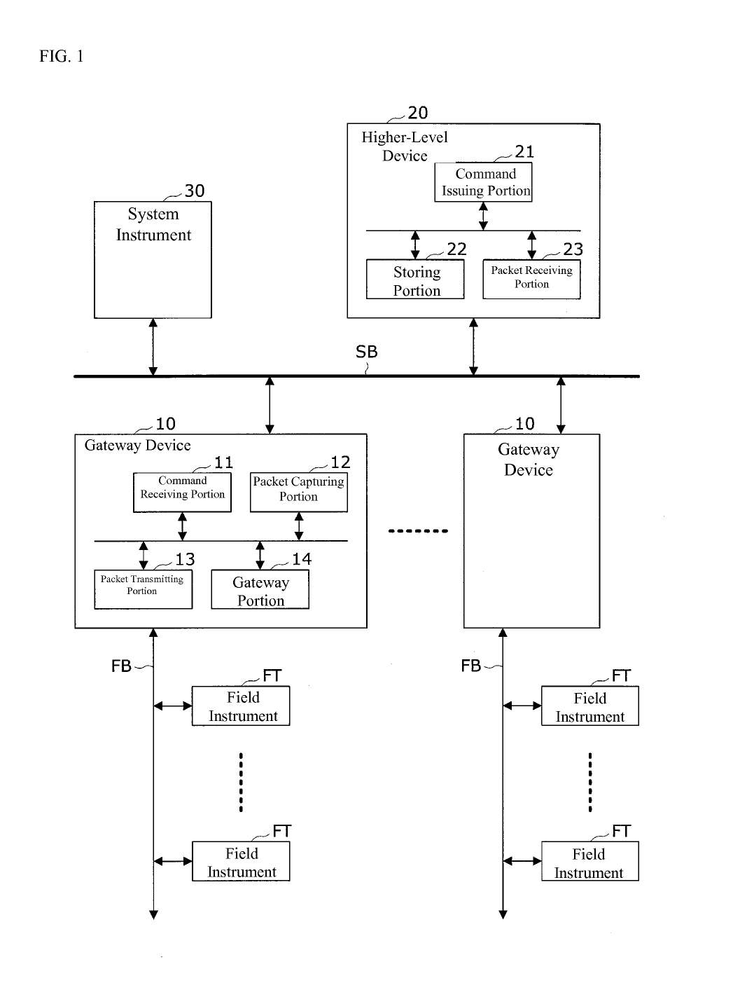

First, a gateway device 10 according to an example will be explained in reference to FIG. 1. FIG. 1 is a block diagram illustrating a structure for a gateway device.

This gateway device 10 is, as a whole, made from an information processing device such as an industrial controller, and, in a controlling system for controlling and monitoring facilities equipment, such as a building or a plant, has a function for relaying a system bus SB, to which the system instrument 30 is connected, and field buses FB, to which field instruments FT are connected.

The system bus SB is a communication network for carrying out data communication between a system instrument 30, made from a server, and the gateway device 10. Moreover, the field bus FB is a communication network for carrying out data communication between the gateway device 10 and a field instrument FT that collects equipment information from sensors, actuators, valves, and the like.

The present invention captures packets that are exchanged between the field bus FB and the field instrument FT in the gateway device 10, and saves the captured packets thus obtained, by transmitting them to a higher-level device 20 that is connected to the system bus SB.

The structure of the gateway device 10 according to the present example and of the higher-level device 20 will be explained in detail next in reference to FIG. 1.

The gateway device 10 is provided with a command receiving portion 11, a packet capturing portion 12, a packet transmitting portion 13, and a gateway portion 14 as the primary functional portions thereof.

The command receiving portion 11 has a function for receiving various types of commands, such as for starting capture and ending capture, sent from the higher-level device 20 through the system bus SB.

The packet capturing portion 12 has a function for capturing, over a specific time, packets exchanged with the field instrument FT through the field bus FB, in response to a start command from the higher-level device 20, received by the command receiving portion 11.

The packet transmitting portion 13 has a function for sending the captured packets, captured by the packet capturing portion 12, along with attribute information, to the higher-level device 20 through capsule packets that are encapsulated based on the communication protocol of the system bus SB.

The gateway portion 14 has a function for relaying between the system bus SB and the field bus FB.

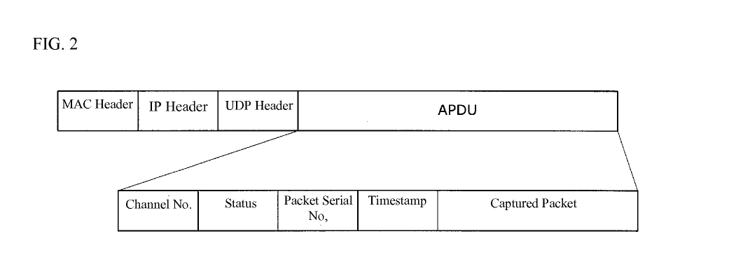

FIG. 2 is an example configuration of a capsule packet. The capsule packet is structured based on the communication protocol that is used in the system bus SB, which, here, is Ethernet. This capsule packet has an MAC header, an IP header, a UDP header, the encapsulated captured packet, and an APDU (Application Protocol Data Unit) that stores the attribute information thereof.

As attribute information, various types of information is stored, such as the channel number, the state (normal/abnormal), a packet serial number, a timestamp, and the like, for the captured packet.

The higher-level device 20 is, as a whole, made from an information processing device such as a server, and is provided with a command issuing portion 21, a storing portion 22, and a packet receiving portion 23, as the primary functional portions thereof.

The command issuing portion 21 has a function for issuing various types of commands, such as for starting capture and ending capture, to the individual gateway devices 10 through the system bus SB.

The storing portion 22 is made from a storing device, such as a hard disk or a semiconductor memory, or the like, and has a function for storing the captured packets from the individual gateway devices 10.

The packet receiving portion 23 has a function for receiving captured packets, sent from the gateway device 10 through the system bus SB, and storing them in the storing portion 22.

### Operation of the Present Example

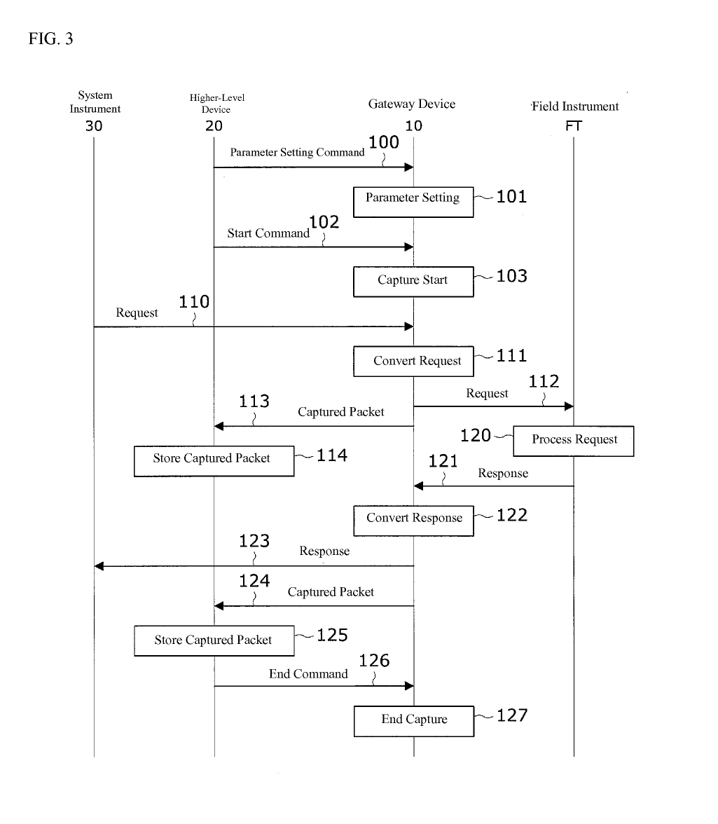

The operation of the gateway device 10 according to the present invention will be explained next in reference to FIG. 3. FIG. 3 is a sequence diagram illustrating a packet capturing operation.

In the higher-level device 20, when carrying out packet capturing at the gateway device 10, first a parameter setting command is sent through the system bus SB to the gateway device 10 from the command issuing portion 21 in order to set parameters regarding the packets to be captured (Step 100). Parameters such as the channel number, port number, and type of protocol for the packets to be captured are defined by this parameter setting command.

In the gateway device 10, the parameter setting command is received by the command receiving portion 11, and the parameters designated by the parameter setting command are set in the packet capturing portion 12 in order to select the packets to be captured (Step 101).

Following this, in the higher-level device 20, a start command, directing that capturing is to be commenced, is sent from the command issuing portion 21 to the gateway device 10 through the system bus SB (Step 102).

In the gateway device 10, this start command is received from the command receiving portion 11, to direct the packet capturing portion 12 to start capture (Step 103). As a result, the packet capturing portion 12 selects, and captures over a specific time interval, those packets that are to be captured, based on the parameters designated by the parameter setting command, from among the packets that are exchanged with the field instrument FT over the field bus FB.

Consequently, while the capturing of packets is being carried out, if a request is sent from the system instrument 30 to a field instrument FT that is provided below the applicable gateway device 10, requesting that a specific procedure be carried out while package capturing is underway (Step 110), the gateway portion 14 of the gateway device 10 converts this request into the protocol of the field bus FB (Step 111) and sends it to the applicable field instrument FT through the field bus FB (Step 112).

In the gateway device 10, the packets pertaining to the request are captured by the packet capturing portion 12 and capsule packets, wherein they are encapsulated together with the attribute information thereof, are sent, by the packet transmitting portion 13, to the higher-level device 20 through the system bus SB (Step 113).

In response thereto, in the higher-level device 20, the capsule packet is received by the receiving portion 23 and the captured packet and attribute information that are encapsulated therein are saved to the storing portion 22 (Step 114).

On the other hand, the procedure directed by the request is carried out in the field instrument FT that has received the request (Step 120), and a response that includes the processing result that is obtained is sent to the gateway device 10 (Step 121).

The gateway portion 14 of the gateway device 10 converts the response from the field instrument FT into the protocol for the system bus SB (Step 122) and sends it through the system bus SB to the system instrument 30 (Step 123).

In the gateway device 10, the packets pertaining to the response are captured by the packet capturing portion 12 and capsule packets, wherein they are encapsulated together with the attribute information thereof, are sent, by the packet transmitting portion 13, to the higher-level device 20 through the system bus SB (Step 124).

In response thereto, in the higher-level device 20, the capsule packet is received by the receiving portion 23 and the captured packet and attribute information that are encapsulated therein are saved to the storing portion 22 (Step 125).

Thereafter, when there is an end command from the higher-level device 20 (Step 126) or a specific amount of time has elapsed since the commencement of capture, the command receiving portion 11 of the gateway 10 instructs the packet capturing portion 12 to stop capture (Step 127). As a result, capturing of packets by the packet capturing portion 12 is terminated.

### Effects of the Present Example

In this way, in the present example, in the gateway device 10 for relaying between the system bus SB and the field bus FB, a packet capturing portion 12 captures, in response to a start command from a higher-level device 20 that is connected to the system bus SB, packets that are exchanged with the field instruments FT over the field busses FB, and, the captured packets are sent to the higher-level device 20 through the system bus SB by the packet transmitting portion 13 after they are encapsulated.

As a result, even when there are multiple field buses FB with different specifications, there is no need to provide dedicated packet capturing devices for each individual field bus FB, and no need to stop a field bus in order to carry out capturing for a new field bus FB, thereby enabling capturing of packets from the individual field busses FB at a low cost with low operational overhead.

Moreover, in the present example, the packet capturing portion 12 may terminate capturing after a specific amount of time has elapsed after a start command or in response to an end command from the higher-level device 20 prior to that specific amount of time elapsing. As a result, it is possible to prevent an increase in the amount of communication on the system bus SB due to the transmission of extraneous captured packages to the higher-level device 20, thereby making it possible to ensure the communication band for the controlling system.

### Expanded Examples

While the present disclosure was explained above in reference to examples, the present disclosure is not limited by the examples set forth above. The structures and details of the present disclosure may be modified in a variety of ways, as can be understood by those skilled in the art, within the scope of the present disclosure.

1: A gateway device for relaying between a system bus, to which a system instrument is connected, and a field bus, to which a field instrument is connected, used in a controlling system for controlling and monitoring facilities equipment, the gateway device comprising:
a packet capturing portion that captures packets that are exchanged with the field instrument over the field bus, in response to a start command from a higher-level device that is connected to the system bus; and
a packet transmitting portion that transmits the captured packets, after encapsulation, to the higher-level device over the system bus.

2: The gateway device as set forth in claim 1, wherein:
the packet capturing portion terminates capturing either after a specific amount of time has elapsed since the start command or in response to an end command from the higher-level device prior to the specific amount of time elapsing.

3: The packet capturing method used in a gateway device for relaying between a system bus, to which a system instrument is connected, and a field bus, to which a field instrument is connected, used in a controlling system for controlling and monitoring facilities equipment, the method comprising:
a packet capturing step for capturing packets that are exchanged with the field instrument over the field bus, in response to a start command from a higher-level device that is connected to the system bus; and
a packet transmitting step for transmitting the captured packets, after encapsulation, to the higher-level device over the system bus.
